(19) United States
(12) Patent Application Publication
(10) Pub. No.: US 2007/0104492 A1
(43) Pub. Date: May 10, 2007

(54) System for and method of single slideband modulation for analog optical link

(75) Inventor: Gary E. Betts, Escondido, CA (US)

Correspondence Address: BURNS & LEVINSON, LLP;(FORMERLY PERKINS SMITH & COHEN LLP), 125 SUMMER STREET, BOSTON, MA, 02110, US

(73) Assignee: IPITEK, Inc., Carlsbad, CA (US)

(21) Appl. No.: 11/592,777

(22) Filed: Nov. 3, 2006

Related U.S. Application Data
(60) Provisional application No. 60/732,970, filed on Nov. 3, 2005.

(51) Int. Cl. H04B 10/04

(52) U.S. Cl. 398/183

(57) ABSTRACT

This invention describes a simple method of producing optical singlesideband suppressed-carrier (SSB-SC) modulation. The SSB-SC transmitter is a Mach-Zehnder interferometric modulator followed by an optical filter. The modulator is biased for minimum transmission of the carrier.

### RELATED APPLICATIONS

This application claims priority of U.S. Provisional Application No. 60/732,970 filed on Nov. 3, 2005, which is hereby incorporated by reference herein.

### BACKGROUND OF THE INVENTION

This invention relates generally to optical analog data links, and, more particularly, to single-sideband optical modulation for use in analog optical signal transmission.

Analog links require high optical power for high performance. Optical power is costly. High optical power can also cause performance problems. In fiber optic transmission, nonlinear optical effects in the fiber can cause distortion. At a photodetector, high power can cause the light-to-current conversion to become nonlinear.

Analog links operate with small optical modulation depth so most of the optical power is actually in the carrier. The information is carried in modulation sidebands which contain only a small part of the power. The minimum optical power that can be transmitted while still preserving all the information in the signal is achieved by transmitting only one of the sidebands and suppressing the carrier. This is known as single sideband suppressed carrier (SSB-SC) transmission.

SSB-SC is a well-known technique at radio frequencies. It has been applied to analog optical transmission, as described in Laurencio and Medeiros, “Dynamic range of optical links employing optical single sideband modulation,” IEEE Photonics Technology Letters vol. 15, pp. 748-750, May 2003, for example. However, SSB-SC is more difficult to apply at optical frequencies than at radio frequencies because the very high frequency of the optical carrier requires a completely different set of techniques for generation of SSB-SC. There have been a few designs for SSB optical transmitters. One that generates SSB-SC is described in Izutsu, Shikama, and Sueta, “Integrated optical SSB modulator/frequency shifter,” IEEE J. Quantum Electronics, vol. 17, pp. 2225-2227, November 1981. This device consists of two optical modulators in parallel, requiring two RF inputs. The outputs of the two modulators must be combined coherently, which in practice requires a phase modulator to maintain the correct relative phase.

Another method of generating SSB is described in Frankel and Esman, “Optical single sideband suppressed-carried modulator for wideband signal processing,” J. Lightwave Technology, vol. 16, pp. 859-863, May, 1998. This uses a single modulator, but the modulator must have two RF inputs so that they can be driven with a fixed RF phase difference. To suppress the carrier, this method uses a fiber interferometer, which is extremely sensitive to environmental effects.

It is therefore a need to provide a simple method of generation of optical SSB-SC modulation.

### SUMMARY OF THE INVENTION

The needs for the invention set forth above as well as further and other needs and advantages of the present invention are achieved by the embodiments of the invention described below.

In one aspect, the present invention provides a transmitter comprised of a single, standard Mach-Zehnder interferometric modulator followed by an optical filter. The modulator is biased for minimum transmission of a optical carrier so as to block the optical carrier. When a signal is applied to the modulator, it generates upper and lower sidebands, which comprise optical signals just above and below the carrier frequency each of which contains all the signal information. The optical filter passes one of the two sidebands. In this way, SSB-SC modulation is achieved using only a single standard modulator and an optical filter. In addition to being simpler than prior art methods of SSB-SC generation, this method also has performance advantages such as a lower noise figure and better tolerance to imperfect modulator extinction.

In another aspect, the present invention provides a method of generating optical SSB-SC modulation using transmitters such as described herein.

In one embodiment, and optical transmitter, comprises a laser energy source, a Mach-Zehnder interferometric modulator oriented to receive a laser energy from the laser energy source and modulate it with a data signal to form a pair of the sideband signals, and a filter oriented to receive modulated laser energy from the modulator and filter out one of the pair of sideband signals.

The modulator may be adapted to suppress a carrier wavelength. The laser source may produce laser energy at a single carrier wavelength, and the modulator may include dual energy pathways for received laser energy and be adapted to cause pi radians interference between the two pathways at the carrier wavelength. The two pathways may be modulated and combined to form an output signal from the modulator. The filter may be adapted to pass only one modulation sideband from the modulator output

In another embodiment, a method for optically transmitting data, comprises the steps of generating laser energy at a carrier wavelength, modulating the laser energy with a Mach-Zehnder interferometric modulator to form a pair of the sideband signals, and filtering one of the pair of sideband signals to allow the other sideband signal to pass.

The method may further comprise the step of biasing the modulator to produce the pi radians interference between a pair of optical pathways to suppress carrier wavelength energy.

One of the pair of optical pathways may be delayed by pi radians at the carrier wavelength prior to modulation of laser energy located in both optical pathways. The step of modulating may include recombining the pair of optical pathways after modulation to suppress the carrier wavelength.

For a better understanding of the present invention, together with other and further needs thereof, reference is made to the accompanying drawings and detailed description and its scope will be pointed out in the appended claims.

### BRIEF DESCRIPTION OF THE FIGURES

For a better understanding of the present invention, together with other and further objects thereof, reference is made to the accompanying drawings and detailed description, wherein:

FIG. 1 is a diagram of a transmitter in accordance with an embodiment of the present invention; and

FIG. 2 is a diagram of an exemplary optical spectrum at various points produced according to a method in accordance with the present invention.

### DETAILED DESCRIPTION OF THE INVENTION

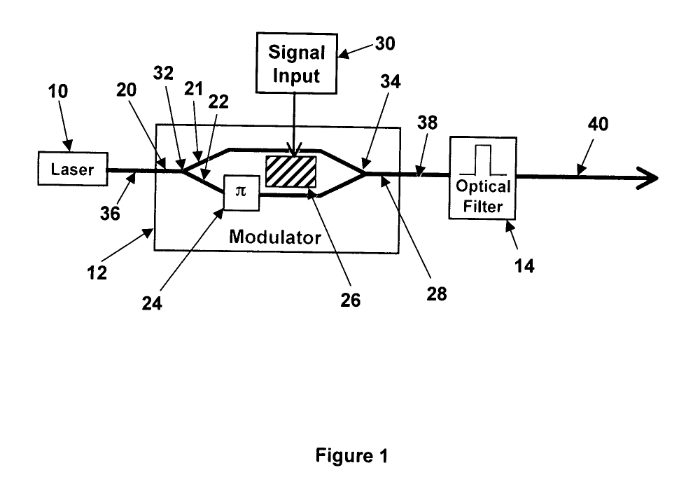

The present invention, in a first aspect, comprises a transmitter for producing optical single-sideband suppressed-carrier modulation. A diagram of a transmitter in accordance with the present invention is shown in FIG. 1. The major components involved include a continuous-wave (cw) laser 10, a Mach-Zehnder interferometric modulator 12, and an optical filter 14.

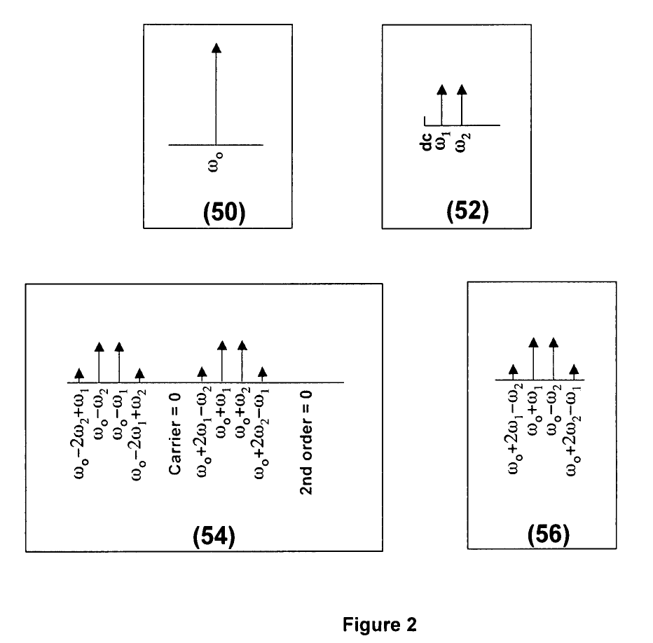

The laser 10 may be of any type that produces an unmodulated, single-frequency optical output. Common, commercially available lasers include semiconductor diode lasers, diode-pumped Nd:YAG lasers, and erbium-doped fiber lasers. Furthermore, laser 10 may have a more complicated structure such as, for example, a structure including a master oscillator and an optical amplifier or slave oscillator. The laser output is substantially a single optical frequency ω₀, as shown in (50) of FIG. 2.

Output from laser 10 is transmitted through a transmission medium 36 to an input of modulator 12. Optical pathway segments 36, 38, 40 are commonly either free-space or single-mode optical fiber. Use of identical types of optical transmission media for optical pathway segments 36, 38, 40 is not required; optical fiber may be used, for example, for segments 36,38 to connect components of the transmitter, while optical radiation from the transmitter may be propagated through free space at the output optical pathway segment 40.

The output of laser 10 is coupled to the input of the modulator 12. The modulator may be formed from any material that exhibits an electro-optic effect. A preferred material is lithium niobate (LiNbO₃), but other materials such as III-V semiconductors, polymers, or other inorganic crystals are also applicable. Light within the modulator 12 is confined to single-mode optical waveguides 20-22 and 28. The waveguides form a Mach-Zehnder interferometer, wherein the input light is split at location 32 into two waveguides 21,22 which later recombine at combiner 34 into the single output waveguide 28. The optical power in the output waveguide 28 depends on the relative phase and intensity of the light entering the combiner 34 from the two waveguides 22. An electrical input signal 30 driving at least a pair of electrodes 26 in proximity to the waveguides 21,22 so as to produce optical phase modulation in one or both of the waveguides. A constant phase difference between waveguides 21,22, or “phase bias point”, of π radians should be introduced at location 24 for optimum operation as an SSB-SC transmitter. This phase difference is most commonly achieved by using a dc bias voltage component in input signal 30 applied to the electrodes 26, but it may also be achieved by alternative means, such as dimensioning waveguides 21,22 to have unequal lengths.

If input signal 30 also includes an ac component comprised of two frequencies ω₁, and ω₂ 52 (as shown in FIG. 2) and the input to modulator 12 on waveguide 20 has a single optical frequency ω₀ 50, the modulator will produce the optical frequency spectrum 54 at its output waveguide 28. The optical carrier ω₀ is completely suppressed, and so are undesirable second-order sidebands. The output on waveguide 28 will comprise upper and lower sidebands containing the desired signals (e.g., ω₀+ω₁), and also a small amplitude of undesirable third-order distortion (e.g.,ω₀+2ω₂−ω₁).

The output of modulator 12 on waveguide 28 and optical pathway segment 38 is then fed through an optical filter 14 to remove one of the sidebands. The filter can be either a bandpass filter or a high- or low-pass filter. Its function is to block one of the two sidebands. A high- or low-pass filter works as well as a bandpass filter because the high-order sidebands (third-order and higher) are small and do not add significantly to the distortion that is already present near the signal frequencies. The filter 14 can be made using a number of known technologies. A fiber Bragg grating is one of the most common and can be made with a bandwidth of <12 GHz, which would be adequate to separate the sidebands produced by signals of several GHz. A narrower bandwidth, which would allow lower modulation frequencies, can be achieved using optical resonator filters. These filters may take the form of an integrated optical device using a waveguide ring or a whispering gallery disc as the resonator, or they may be discrete microspheres or microtoruses. Many such filters are described in the technical literature. An example of a filter based on a waveguide ring resonator is given in Bourden, et al., “Ultralow loss ring resonators using 3.5% index-contrast Ge-doped silica waveguides,” IEEE Photonics Technology Letters vol. 15, pp. 709-711, May 2003. Microsphere resonators, while more difficult to use in filters, offer very high Q factors (>10⁸) which result in very narrow bandwidths. Such high Q could enable a filter that could separate a sideband from the carrier when the two are just a few MHz apart. An example of a microsphere optical filter is given in Ilchenko, et al., “Coupling of light from a high-Q microsphere resonator using a UV-induced surface grating,” Lasers and Electro-Optics Conference Technical Digest (CLEO '99), p. 67, May, 1999. After the filter 14, an optical signal having a single sideband suppressed carrier spectrum 58 is output to optical pathway segment 40 ready for transmission.

In another aspect, the present invention provides systems that utilize optical links as described above. For example, in a fiberoptic system embodiment of the present invention, analog signals may be transmitted over wavelength-multiplexed fiberoptics in environments where both analog and digital signals are mixed and excessive power for the analog signal would be a problem for conventional transmitters. This could be a network, such as is found in cable TV distribution systems, or in the “fiber-to-the-home” systems phone companies are deploying to carry video and compete with the cable companies. In another embodiment involving free-space optical communication, the present invention allows the signal to be amplified at the transmitter to a level that will overcome transmission loss. Normal analog modulation would require a large amount of power to be generated, while the present SSB technique could reduce that by a factor of as much as 1000. Free-space optical links are most likely to be used in applications.

Although The Invention Has Been Described With Respect To Various Embodiments, It Should Be Realized This Invention Is Also Capable Of A Wide Variety Of Further And Other Embodiments Within The Spirit And Scope Of The Appended Claims.

What is claimed is:

1. An optical transmitter, comprising:
a laser energy source;
a Mach-Zehnder interferometric modulator oriented to receive a laser energy from the laser energy source and modulate it with a data signal to form a pair of the sideband signals; and
a filter oriented to receive modulated laser energy from the modulator and filter out one of the pair of sideband signals.

2. The transmitter of claim 1, wherein the modulator is adapted to suppress a carrier wavelength.

3. The transmitter of claim 2, wherein the laser source produces laser energy at a single carrier wavelength, and further wherein the modulator includes dual energy pathways for received laser energy and is adapted to cause pi radians interference between the two pathways at the carrier wavelength.

4. The transmitter of claim 3, wherein the two pathways are modulated and combined to form an output signal from the modulator.

5. The transmitter of claim 1, wherein the filter is adapted to pass only one modulation sideband from the modulator output.

6. A method for optically transmitting data, comprising the steps of:
generating laser energy at a carrier wavelength;
modulating the laser energy with a Mach-Zehnder interferometric modulator to form a pair of the sideband signals; and
filtering one of the pair of sideband signals to allow the other sideband signal to pass.

7. The method of claim 5, further comprising the step of biasing the modulator to produce the pi radians interference between a pair of optical pathways to suppress carrier wavelength energy.

8. The method of claim 7, wherein one of the pair of optical pathways is delayed by pi radians at the carrier wavelength prior to modulation of laser energy located in both optical pathways.

9. The method of claim 8, wherein the step of modulating includes recombining the pair of optical pathways after modulation to suppress the carrier wavelength.
